(19) United States
(12) Patent Application Publication
(10) Pub. No.: US 2004/0228564 A1
(43) Pub. Date: Nov. 18, 2004

(54) External cavity laser source

(75) Inventors: Lawrence C. Gunn III, Encinitas, CA (US); Thierry J. Pinguet, Cardif-By-The-Sea, CA (US); Maxime J. Rattier, Paris (FR)

Correspondence Address: Fernandez & Associates, LLP, PO Box D, Menlo Park, CA, 94026-6402, US

(73) Assignee: Luxtera, Inc., Carlsbad, CA

(21) Appl. No.: 10/777,702

(22) Filed: Feb. 11, 2004

Related U.S. Application Data
(60) Provisional application No. 60/446,842, filed on Feb. 11, 2003.
(60) Provisional application No. 60/446,843, filed on Feb. 11, 2003.
(60) Provisional application No. 60/446,844, filed on Feb. 11, 2003.
(60) Provisional application No. 60/446,845, filed on Feb. 11, 2003.
(60) Provisional application No. 60/446,846.
(60) Provisional application No. 60/446,847, filed on Feb. 11, 2003.

(51) Int. Cl. G02F 1/01

(52) U.S. Cl. 385/1

(57) ABSTRACT

A multi-wavelength light source with a gain medium and an optical equalizer. The gain medium emits light of a plurality of wavelengths in response to pumping. The gain medium is disposed in an optical cavity that repetitively passes light through the gain medium. The optical cavity supports a plurality of different optical modes having wavelengths coinciding with the plurality of wavelengths emitted by the gain medium. The optical equalizer is also in the optical cavity. The optical equalizer adjusts the optical power of at least one of the different optical modes so as to provide more even optical power distribution among the optical modes propagating through the optical cavity.

### CROSS REFERENCE TO RELATED APPLICATIONS

This application claims the benefit of U.S. Provisional Applications No. 60/446,842, 60/446,843, 60/446,844, 60/446,845, 60/446,846 and 60/446,847, all of them filed on Feb. 11, 2003.

### FIELD OF INVENTION

The present invention is directed to light sources, and more particularly to multi-wavelength laser sources such as for use in fiber optic communications systems.

### BACKGROUND OF INVENTION

Fiber optic communications systems utilize optical signals that are transmitted along optical fibers. Such systems provide numerous advantages over electrical communication systems such as increased speed and increased bandwidth. In an exemplary fiber optic communication system, a continuous wave (“CW”) beam of light is generated and modulated using an electro-optical modulator driven by an electrical signal so as to produce an optical signal encoded with information such as voice or image data. This optical signal is then transmitted between two locations (e.g., two components in a computer, two computers in a network, or two telephones across the country or the world). The optical signal propagates along an optical fiber to a location where it is detected by an optical sensor, which outputs an electrical signal that varies in accordance with the modulation of the optical signal. In this manner, information can be rapidly transmitted from one location to another. To increase the data throughput, numerous optical signals or channels, each with a different wavelength, can be multiplexed and transmitted along a single optical path. This optical path can be switched and varied selectively to direct the various optical channels to their appropriate destinations.

In such optical communications systems, it is desirable to generate light having a plurality of wavelengths corresponding to the wavelengths of the plurality of channels. For example, a plurality of laser diodes can be used as a plurality of light sources, each with a corresponding wavelength.

### SUMMARY OF INVENTION

The present invention provides an external cavity laser source that can provide multi-wavelength light for use in optical communication systems.

One aspect of the invention comprises a multi-wavelength light source comprising a gain medium and an optical equalizer. The gain medium emits light of a plurality of wavelengths in response to pumping and is disposed in an optical cavity that repetitively passes light through the gain medium. The optical equalizer is also in the optical cavity. The optical equalizer adjusts the optical power of at least one of the wavelengths so as to provide more even optical power distribution among the plurality of wavelengths propagating through the optical cavity.

Another aspect of the invention comprises a method of producing a plurality of optical outputs at different wavelengths. In this method, a laser gain medium is pumped to generate light having a plurality of different wavelengths. The light of the plurality of different wavelengths is resonated in an optical cavity. A more even distribution of optical power is provided among the plurality of different wavelengths resonating in the optical cavity by adjusting the optical power of at least one of the wavelengths. A fraction of the light propagating through the optical cavity is coupled out of the optical cavity.

Yet another aspect of the invention comprises a method of producing optical channels for optical communications. In this method, laser light is generated through at least a substantial portion of the gain bandwidth of a laser medium disposed in a resonant cavity. The laser light is output from the laser medium as a gain medium output. Plural discrete communication signals are simultaneously generated from the laser light by repetitively modifying the optical power distribution of the gain medium output and repetitively feeding the modified gain medium output back to the laser medium.

Still another aspect of the invention comprises a multi-channel light source comprising a gain medium and an optical equalizer. In response to pumping, the gain medium emits light of a plurality of wavelengths. The gain medium is disposed in an optical cavity that repetitively passes light through the gain medium. Lasing is provided for said plurality of wavelengths that coincide with different cavity modes. The optical equalizer is also in the optical cavity. The optical equalizer adjusts the optical power of at least one of the different cavity modes so as to provide a more even optical power distribution among the modes propagating through the optical cavity. These modes preferably correspond to longitudinal or axial cavity modes as well as channels output by the multi-channel light source.

### BRIEF DESCRIPTION OF DRAWINGS

These and other features of the invention will now be described with reference to the drawings summarized below. These drawings and the associated description are provided to illustrate preferred embodiments of the invention and are not intended to limit the scope of the invention.

FIG. 1 schematically illustrates an embodiment of a multi-wavelength light source comprising an optical cavity with a gain medium therein, a reflector defining one end of the optical cavity, and an optical equalizer optically coupled to one end of the gain medium.

FIG. 2 schematically illustrates an embodiment of the multi-wavelength light source with an optical equalizer comprising a pair of multiplexer/demultiplexers (“mux/demuxes”).

FIG. 3A schematically illustrates an embodiment of the multi-wavelength light source with an optical equalizer comprising a plurality of ring resonators.

FIGS. 3B and 3C schematically illustrate the filtering behavior of the ring resonators.

FIG. 3D schematically illustrates another embodiment of the multi-wavelength light source with an optical equalizer comprising a plurality of ring resonators.

FIG. 3E schematically illustrates still another embodiment of the multi-wavelength light source with an optical equalizer comprising a plurality of ring resonators.

FIG. 4 schematically illustrates an embodiment of the multi-wavelength light source with an optical equalizer comprising a plurality of band pass filters for respective channels of the multi-wavelength light source.

FIG. 5 schematically illustrates an embodiment of the multi-wavelength light source with an optical cavity with a gain medium therein and an optical equalizer optically coupled to both ends of the gain medium to form a ring resonator configuration.

FIG. 6A schematically illustrates an embodiment of the multi-wavelength light source with an optical power monitor optically coupled to the optical cavity via a plurality of taps to monitor the relative strength of the respective channels.

FIG. 6B schematically illustrates an embodiment of the multi-wavelength light source with an optical power monitor optically coupled to the optical cavity via a single tap and a demultiplexer.

FIG. 7 is a flowchart of an embodiment of a method of producing a plurality of optical outputs at different wavelengths.

FIG. 8A schematically illustrates an exemplary gain bandwidth of a laser gain medium in accordance with embodiments described herein.

FIG. 8B schematically illustrates exemplary axial or longitudinal mode resonances for an optical resonator.

FIG. 8C schematically illustrates a resultant optical power distribution derived by convolving the gain distribution shown in FIG. 8A with the plurality of the axial mode resonances depicted in FIG. 8B.

FIG. 8D schematically illustrates an exemplary optical power distribution in which the optical power is more evenly distributed among the plurality of different axial or longitudinal modes resonating in the optical cavity.

FIG. 9 is a flowchart of an embodiment of a method of producing optical signals for optical communications.

FIG. 10 schematically illustrates an embodiment of the multi-wavelength light source that transmits the discrete communication channels to a modulator array using a tap from the resonant cavity and a demultiplexer between the tap and the modulator array.

### DETAILED DESCRIPTION OF PREFERRED EMBODIMENT(S)

Although this invention will be described in terms of certain preferred embodiments, other embodiments that are apparent to those of ordinary skill in the art, including embodiments that do not provide all of the benefits and features set forth herein, are also within the scope of this invention. Accordingly, the scope of the invention is defined only by reference to the appended claims.

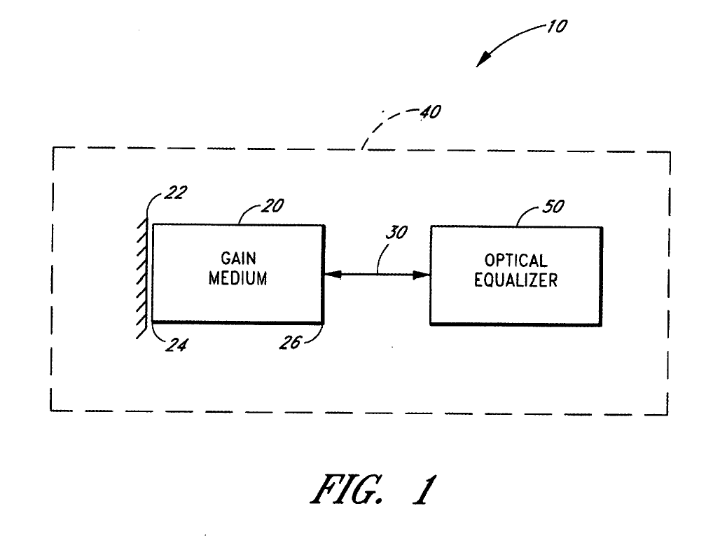

As schematically illustrated by FIG. 1, a multi-wavelength light source 10 in accordance with embodiments described herein comprises a gain medium 20 that emits light 30 of a plurality of wavelengths in response to pumping. The gain medium 20 is disposed in an optical cavity 40 that causes light to repetitively pass through the gain medium 20. The multi-wavelength light source 10 further comprises an optical equalizer 50 in the optical cavity 40. The optical equalizer 50 adjusts the optical power of at least one of the wavelengths so as to provide more even optical power distribution among the plurality of wavelengths propagating through the optical cavity 40.

As described herein, the term “optical cavity” is used in its conventional meaning as an optical resonator, a region through which the light 30 emitted by the gain medium 20 repetitively passes. The optical cavity 40 includes the gain medium 20 therein and the optical equalizer 50 which may be in the optical cavity 40, form part of it or both, as schematically illustrated by FIG. 1.

In certain embodiments, the gain medium 20 is a solid state device and preferably comprises semiconductor material. More preferably, the gain medium 20 comprises a III-V semiconductor material. In various preferred embodiments, an indium-phosphide-based gain medium which emits light when powered electrically. The indium-phosphide (InP) gain medium may be formed on a substrate and comprise a multilayer heterostructure. Examples of other III-V semiconductor materials include but are not limited to GaAs, GaAlAs, AlAs, GaN and variants of these materials. Other III-V semiconductors as well as non III-V materials may also be employed.

In certain other embodiments, the gain medium 20 comprises an erbium-doped glass fiber. Other gain media 20 that emit light 30 of a plurality of wavelengths in response to pumping may be suitable and should not be restricted to those explicitly recited herein.

As schematically illustrated in FIG. 1, in certain embodiments, the optical cavity 40 comprises a reflector 22 at a first end 24 of the gain medium 20 and the gain medium 20 emits light through a second end 26. In certain embodiments, the reflector 22 comprises, but not limited to, a dielectric mirror coated onto the first end 24 of the gain medium 20. The dielectric mirror of certain embodiments has a high reflectivity over the bandwidth of the gain spectrum of the gain medium 20.

The gain medium 20 is preferably optically coupled to the optical equalizer 50 via one or more optical waveguides. These optical waveguides can be integrated optical waveguides and may comprise semiconductor such as silicon. These waveguides are preferably formed on a substrate such as a silicon substrate and may be formed as part of a silicon-on-insulator (SOI) substrate. The waveguides are preferably integrated together on an integrated optical chip with the optical equalizer 50. Examples of optical waveguides compatible with embodiments described herein include, but are not limited to, ridge waveguides, channel waveguides, slab waveguides, strip loaded waveguides and strip loaded waveguides with low index transition layers. Exemplary waveguide structures and methods for fabricating such waveguides and waveguide structures on substrates are disclosed in U.S. patent application Ser. No. 10/241,284 entitled “Strip Loaded Waveguide with Low-Index Transition Layer” filed Sept. 9, 2002, as well as U.S. patent application No. 10/242,314 entitled “Tunable Resonant Cavity Based on the Field Effect in Semiconductors” filed Sept. 10, 2002, both of which are hereby incorporated herein by reference in their entirety. Other configurations are considered possible and may be more suitable for specific applications. For example, photonic bandgap crystal waveguides may be used. See, for example, U.S. patent application Ser. No. 10/242,682 entitled “Structure and Method for Coupling Light Between Dissimilar Waveguides” filed Sept. 10, 2002, which is also hereby incorporated herein by reference in its entirety. Nevertheless, the usable waveguide structures are not to be limited to those described herein and may include types yet to be discovered or developed.

In certain such embodiments, the waveguides are optically coupled to the gain medium 20 by physical alignment in close proximity, which includes a configuration known as “butt-coupling.” The coupling region between the gain medium 20 and the optical waveguides of certain embodiments is preferably designed to have a low reflectivity by using a combination of antireflection coatings and/or angled chip interfaces. In addition, the semiconductor optical amplifier (SOA) and waveguide modes are preferably closely matched to promote efficient coupling.

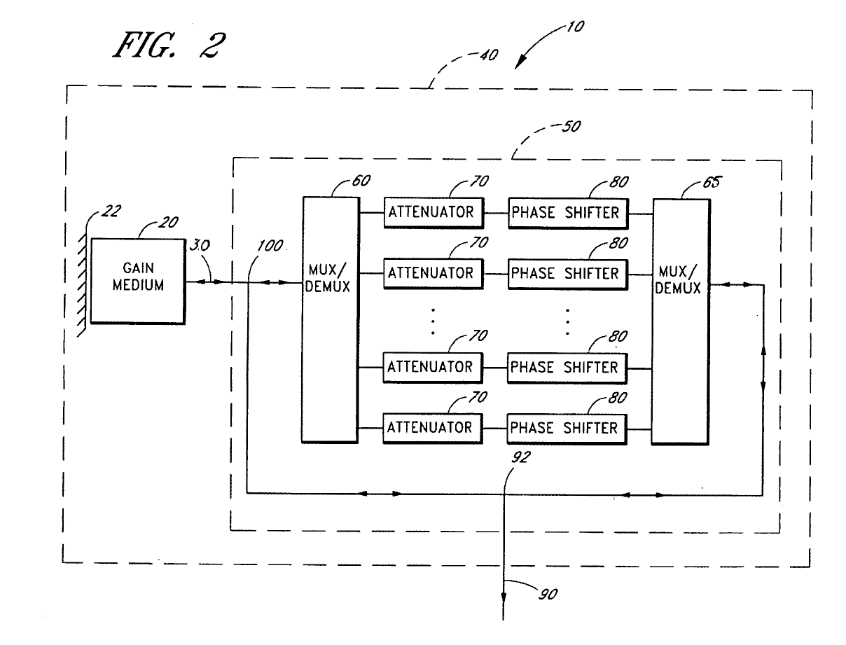

FIG. 2 schematically illustrates an embodiment of the multi-wavelength light source 10 that utilizes an optical equalizer 50 optically coupled to the gain medium 20. The optical equalizer 50 comprises a plurality of optical paths for respective channels corresponding to the plurality of axial or longitudinal modes supported by the resonant cavity 40. A first multiplexer/demultiplexer (“mux/demux”) 60 and a second mux/demux 65 allow only one of the channels to propagate through each of the respective optical paths. The optical paths are optically coupled to one another in parallel, and each path comprises an attenuator 70 and a phase shifter 80 optically coupled to one another in series. Each path for a given channel receives the corresponding wavelength from the light 30 emitted from the gain medium 20 and most of the light transmitted through each channel path is returned to the gain medium 20. A portion of the light transmitted through the optical equalizer 50 is outputted from the optical cavity 40 through a tap 90.

An example of a multiplex/demultiplexer compatible with embodiments described herein is an arrayed waveguide grating (“AWG”) which can be used as either a multiplexer or as a demultiplexer. Such AWGs comprise a primary waveguide for the multiplexed light and an array or plurality of waveguides for separated demultiplexed beams. When used as a demultiplexer, the primary waveguide of the AWG receives multiplexed light comprising a plurality of wavelengths and the AWG transmits the different channels to separate branches or arms of the AWG for propagation of the corresponding demultiplexed beams. When used as a multiplexer, each arm or branch in the array of waveguides for the demultiplexed light beams receives light corresponding to a different channel, and the AWG transmits the different wavelengths to the primary waveguide for propagating the multiplexed beam. Other variations of the AWG as well as other types of mux/demuxes, such as interleavers and ring resonators, are also possible.

In certain embodiments, as schematically illustrated by FIG. 2, each of the array of waveguide for the separate channels in the first mux/demux 60 is optically coupled to a corresponding waveguide of the second mux/demux 65, with an attenuator 70 and phase shifter 80 optically coupled in series therebetween. Thus, each attenuator 70/phase shifter 80 pair is part of an optical path corresponding to a particular channel.

The variable attenuators 70 are preferably configured to controllably attenuate the light that passes through the corresponding optical path for the designated channel. Accordingly, the attenuator 70 can controllably adjust the optical power of the wavelength or wavelengths for the corresponding channel. In certain such embodiments described more fully below, the attenuator 70 is responsive to a feedback signal representative of the optical power of the light for that channel. One example of an attenuator 70 compatible with embodiments described herein is a variable Mach-Zehnder interferometer, which can be used as a continuously variable 1×2 switch, or as an amplitude modulator. Other examples of attenuators 70 compatible with embodiments described herein include, but are not limited to, a Variable Optical Attenuator (VOA) device, such as one that controllably absorbs light. The VOA may be based on free-carrier absorption or other conventional technologies.

In addition, phase shifters 80 are preferably configured to controllably shift the phase of the light that passes through optical path for the corresponding channel. Preferably, the phase shifters tune the optical path for the respective channel to satisfy the resonance condition. In particular, the phase shifters 80 adjust the phase of the light passing through the respective optical path so that the optical length traversed by the light through the optical cavity 40 and along the channel path is an integral multiple of the corresponding wavelength. Constructive interference is thereby provided, and the cavity is tuned to resonance the specific channel. As the different channels correspond to different wavelengths propagating along non-identical optical paths, the appropriate amount of phase shift is preferably tailored for the specific channel. Accordingly, a plurality of such phase shifters 80 are included in the plurality of channel paths. In certain such embodiments described more fully below, the phase shifter 80 is responsive to a feedback signal representative of the phase and/or intensity of the particular channel. One example of a phase modulator 80 compatible with embodiments described herein is an electroded silicon waveguide that changes its refractive index and optical path length in response to variable applied voltages. See for example U.S. patent application Ser. No. 10/241,285 entitled “Electronically Biased Strip Loaded Waveguide” filed Sept. 9, 2002, which is hereby incorporated herein by reference in its entirety.

In certain embodiments, the tap 90 is optically coupled to the optical equalizer 50 and is configured to output light from the optical cavity 40. In certain such embodiments, the tap 90 comprises a Y-coupler 92 that receives the light from the optical equalizer 50 and outputs a fraction of the light from the optical cavity 40. The fraction of light outputted from the optical cavity 40 by the tap 90 is preferably approximately 1% of the light received from the optical equalizer 50, more preferably less than approximately 1%. Other types arrangements for tapping off a portion of the light, such as partially reflective and partially transmissive surfaces, may be employed as well.

The gain medium 20 may be optically coupled to the optical equalizer 50 via a Y-coupler 100 which transmits a first fraction of the light 30 from the gain medium 20 to the first mux/demux 60 of the optical equalizer 50 and the remaining second fraction of the light 30 from the gain medium 20 to the second mux/demux 65. In certain such embodiments, the first fraction and second fraction have approximately equal optical power distributions, while in other such embodiments, the first and second fractions are unequal.

The first mux/demux 60 demultiplexes the first fraction of light received from the gain medium 20 into the plurality of separate wavelengths and channels, with each branch of the mux/demux 60 receiving the appropriate channel. The light transmitted through the attenuator 70 and phase shifter 80 in each branch is multiplexed by the second mux/demux 65 and the multiplexed light propagates back to the gain medium 20 via the Y-coupler 100. Similarly, the second mux/demux 65 demultiplexes the second fraction of light received from the gain medium 20 into the plurality of separate wavelengths and channels, with each branch of the mux/demux 65 receiving the corresponding channel. The light transmitted through the channel paths or branches is multiplexed by the first mux/demux 60 and the multiplexed light propagates back to the gain medium 20 via the Y-coupler 100. Thus, light 30 from the gain medium 20 is propagating through the optical equalizer 50 in both directions simultaneously. In other embodiments, the optical cavity 40 comprises an optical isolator so that the light 30 from the gain medium 20 propagates through the optical equalizer 50 in only one direction.

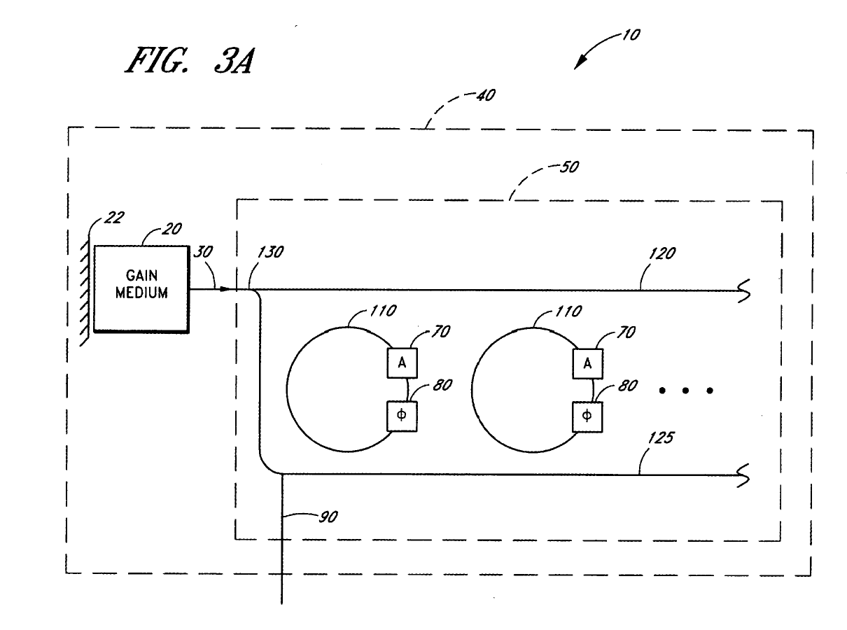

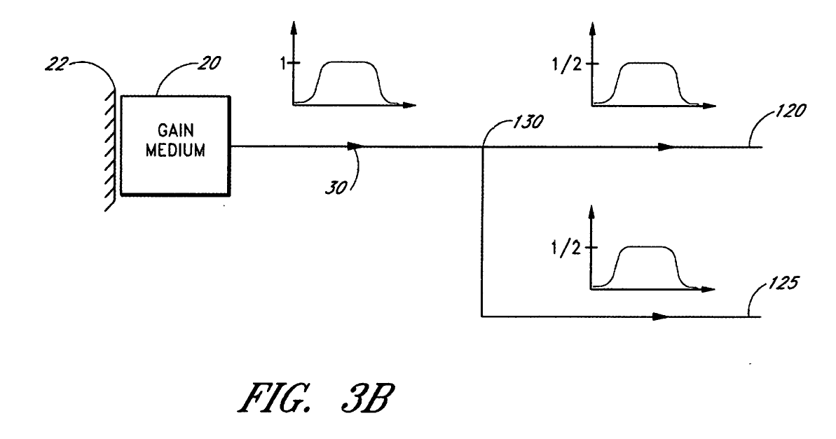

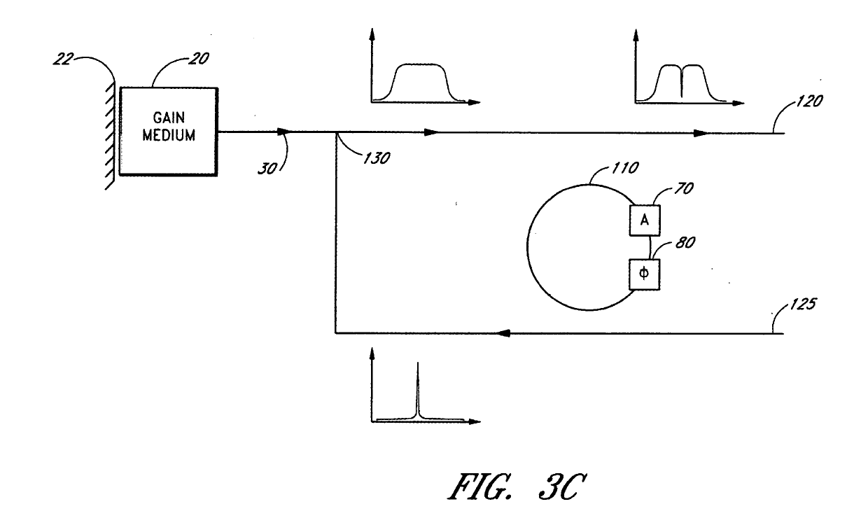

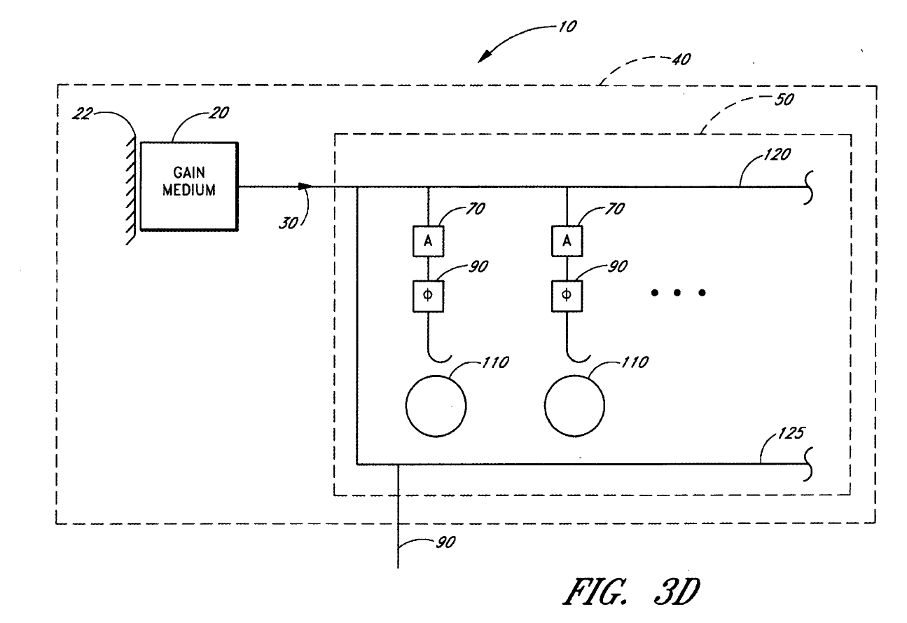

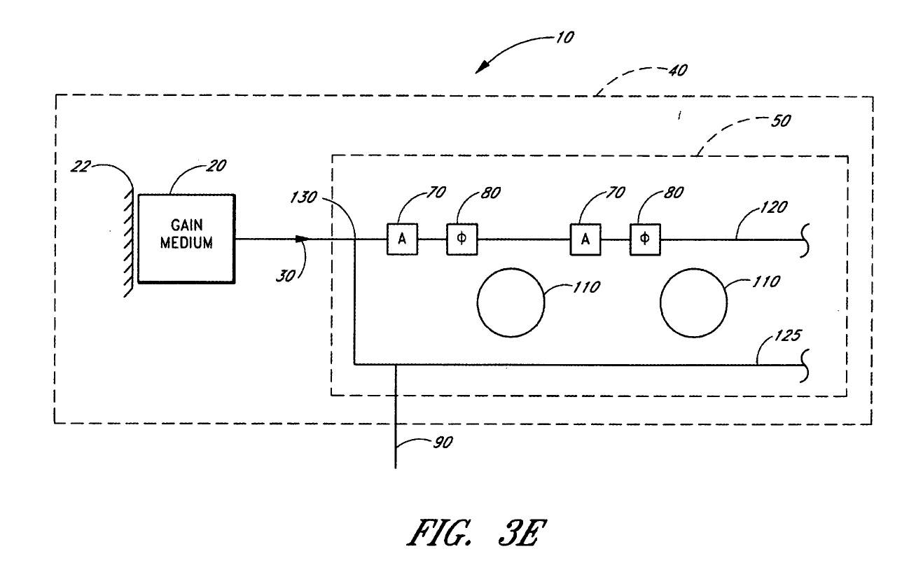

FIG. 3A schematically illustrates a multi-wavelength light source 10 with an optical equalizer 50 comprising a plurality of ring resonators 110 which are optically coupled in parallel to a first waveguide 120 and a second waveguide 125 in accordance with one embodiment of the present teachings. The first waveguide 120 and second waveguide 125 are also optically coupled by a Y-coupler 130 that is optically coupled to the gain medium 20. As described above in relation to FIG. 2, the Y-coupler 130 transmits a first fraction of the light 30 from the gain medium 20 to the first waveguide 120 and the remaining second fraction of the light 30 to the second waveguide 125. In another embodiment, the first and second waveguides may be connected through another Y-junction (not shown in FIG. 3A), but care must be taken to ensure that they are combined in phase. This would occur either through careful design, or incorporation of a phase modulator in one or both of the arms just prior to the Y-junction. Another alternative is to just keep them separate, in which case there will be two multi-wavelength source outputs, although at lower power each.

Each ring resonator 110 includes an attenuator 70 and a phase shifter 80 optically coupled in series. Preferably, each ring resonator 110 corresponds to one of the channels, i.e., one of the axial or longitudinal modes of the optical cavity 40, and has an optical path length that is an integral multiple of the corresponding wavelength. In such embodiments, each ring resonator 110 is resonant at the corresponding wavelength, so the ring resonator 110 acts as a bandpass filter by optically coupling the first waveguide 120 to the second waveguide 125 for the corresponding wavelength of the ring resonator 110. Suitable ring resonators 110 are described more fully in U.S. patent application Ser. No. 10/242,314, filed Sept. 10, 2002, entitled “Tunable Resonant Cavity Based on the Field Effect in Semiconductors,” which is incorporated in its entirety by reference herein. Other types of filters may be employed as well in other embodiments.

FIGS. 3B and 3C schematically illustrate the filtering behavior of the ring resonators 110 of FIG. 3A. In FIGS. 3B and 3C, the optical power distributions of light at various portions of the optical equalizer 50 are schematically illustrated by the inset graphs. As shown by FIG. 3B, the light 30 from the gain medium 20 is split and transmitted to the first waveguide 120 and the second waveguide 125. In certain such embodiments, the first fraction and the second fraction have approximately equal optical power distributions, while in other such embodiments, the first and second fractions are unequal.

As illustrated by FIG. 3C, the first fraction of light propagates along the first waveguide 120 that is optically coupled to the second waveguide 125 through the ring resonator 110. Because the ring resonator 110 only couples to light having a wavelength substantially equal to one of the resonant wavelengths of the ring resonator 110, the ring resonator 110 preferably only transmits a single wavelength band corresponding to one of the longitudinal modes of the laser 10 from the first waveguide 120 to the second waveguide 125. This wavelength band is dropped from the first waveguide 120 and returned to the gain medium 20 via the second waveguide 125 and the Y-coupler 130. Similarly, the ring resonator 110 passes a single wavelength band corresponding to one of the longitudinal modes from the second fraction of light propagating along the second waveguide 125 into the first waveguide 120. In this way, the ring resonator 110 filters a narrow-band portion of the light from one waveguide to the other. This narrow-band portion preferably corresponds to one of the axial or longitudinal modes (i.e., channels) of the multi-wavelength laser source 10.

As schematically illustrated by FIG. 3A, in certain embodiments, each channel path comprises an attenuator 70 and a phase shifter 80. The attenuator 70 for each channel is configured to controllably attenuate the light that passes through the corresponding ring resonator 110. In this way, the attenuator 70 adjusts the optical power of the channel. In certain such embodiments described more fully below, the attenuator 70 is responsive to a feedback signal representative of the optical power at the relevant resonant wavelength of the ring resonator 110.

As described above, examples of attenuators 70 include, but are not limited to, variable Mach-Zehnder interferometers. The Mach-Zehnder interferometer includes an input that branches out into two arms at least one of which includes a phase shifter. The phase shifter in the Mach-Zehnder can be adjusted to induce a relative phase difference between lights propagating in the two arms. Destructive and/or constructive interference can be produced between the light within the to arms that is coupled together at the output of the interferometer. The output intensity of the interferometer can thereby be controlled. Other types of attenuators 70 can also be employed to vary the strength of the various channels.

As discussed above, the phase of the different channels is preferably controlled as well. The phase shifters 80 for the different channels are configured to controllably shift the phase of the light that passes through the associated ring resonator 110. In this way, the phase shifter 80 adjusts the phase of the channel so that the resonance condition of the laser can be satisfied. In particular, the optical path length traversed by the light through the optical cavity 40, including the channel path, is preferably an integral multiple of the corresponding wavelength so as to produce constructive interference. In certain such embodiments described more fully below, the phase shifter 80 is responsive to a feedback signal representative of the phase and/or intensity of the channel. As described above, examples of a phase modulator 80 compatible with embodiments described herein include, but are not limited to, a waveguide with a refractive index responsive to applied voltage.

FIG. 3D schematically illustrates another multi-wavelength light source 10 with an optical equalizer 50 in accordance with embodiments described herein. Each optical path for the different channels includes an attenuator 70, a phase shifter 80, and a ring resonator 110. In the embodiment illustrated by FIG. 3D, the attenuator 70 and the phase shifter 80 are not part of the ring resonator 110.

In another embodiment shown in FIG. 3E, the attenuator 70 and the phase shifter 80 corresponding to different channel paths are positioned along one or both of the waveguides 120, 125. For example, in the embodiment schematically illustrated by FIG. 3E, the attenuator 70 and phase shifter 80 are optically coupled in series along the first waveguide 120. Other embodiments have the attenuator 70 and/or the phase shifter 80 optically coupled in series with the second waveguide 125. Because the attenuators 70 and phase shifters 80 of such embodiments affect multiple wavelengths, the algorithm for controllably adjusting the optical power distribution or phase of the different wavelengths can be complex.

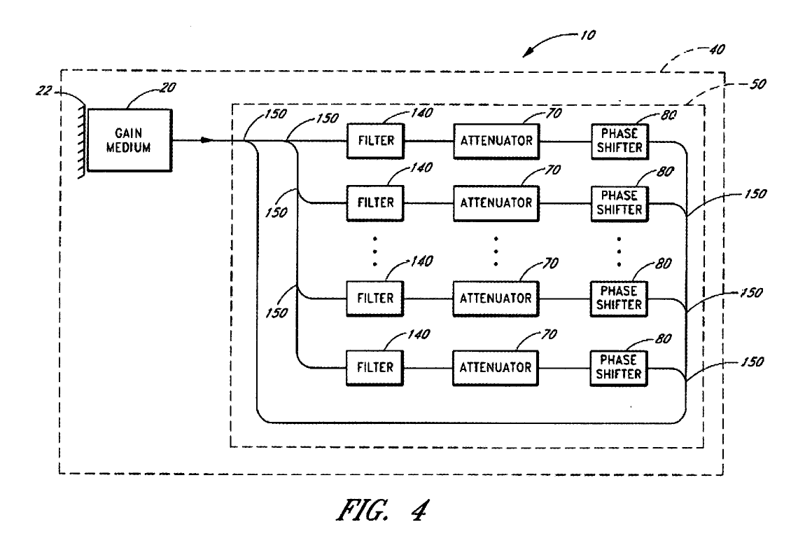

FIG. 4 schematically illustrates another multi-wavelength light source 10 with an optical equalizer 50 wherein the optical paths for the different channels includes a corresponding channel filter 140. Each channel filter 140 is optically coupled in series with the attenuator 70 and phase shifter 80 for the corresponding channel. In certain embodiments, the channel filters 140 are configured to pass light of a predetermined wavelength or wavelength band, with the different channel filters 140 passing different wavelengths. In this way, the various optical paths are dedicated to a particular axial or longitudinal mode and corresponding optical frequency which is allowed to pass through the channel filter 140. In certain embodiments, the channel filters 140 are tunable to select the wavelength which propagating along through the channel path. One example of a channel filter 140 compatible with embodiments described herein is a ring resonator, as described above, certain embodiments that may be tunable. Other examples of channel filters 140 compatible with embodiments described herein include, but are not limited to, Bragg gratings, interleavers and other conventional types of resonant cavities.

The various optical paths for the different channels may be optically coupled to one another in parallel via a plurality of Y-couplers 150. As such, light received by the optical equalizer 50 is distributed among the plurality of optical paths, and the light from each of the optical paths for the different channels is recombined to be outputted from the optical equalizer 50. Other configurations for optically coupling the channel paths in parallel to one another are also possible.

As schematically illustrated in FIG. 5, in certain embodiments, the optical cavity 40 is not defined by a reflector, and the optical equalizer 50 is optically coupled to both the first end 24 of the gain medium 20 and the second end 26 of the gain medium 20. The result is a multi-wavelength laser source 10 having a ring resonator. In such cases, the couplings between the gain medium 20 and the optical waveguides of the optical equalizer 50 are preferably designed to have a low reflectivity as described above.

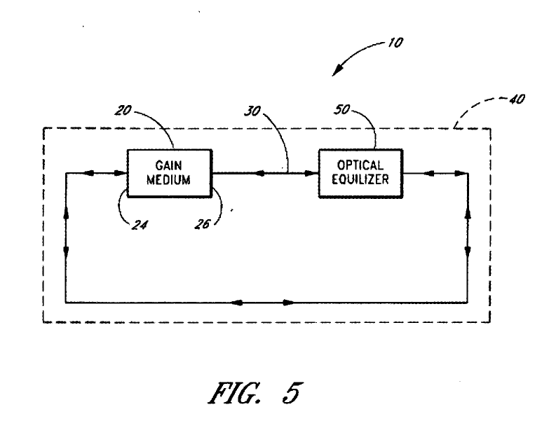

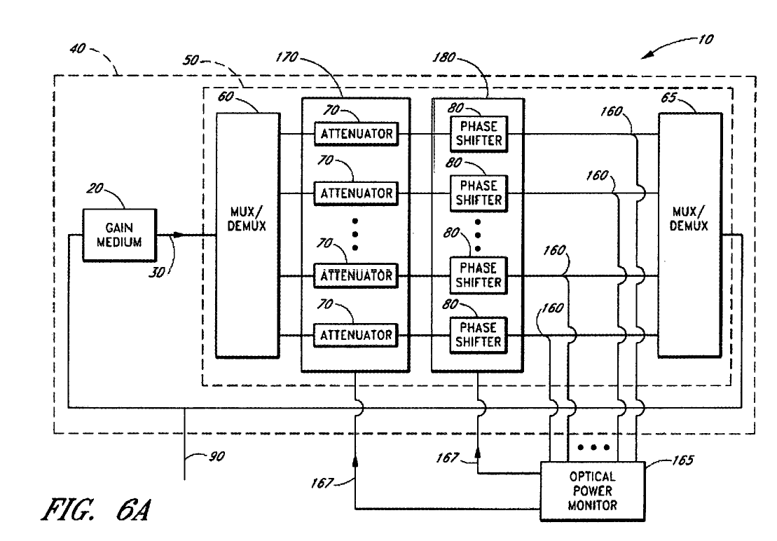

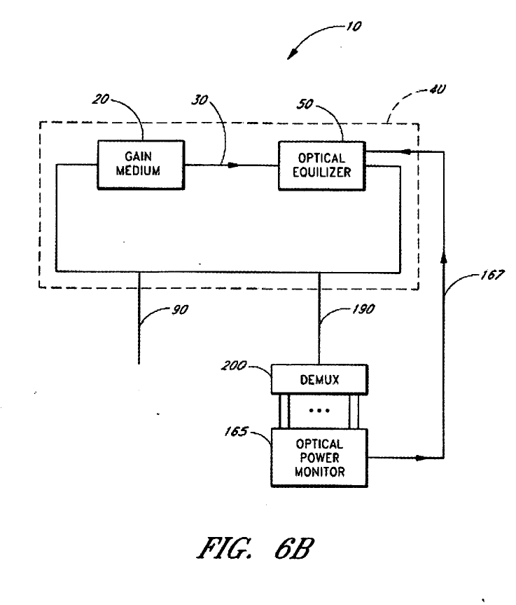

Each of the optical paths for the different channels may further comprise a tap 160 that is optically coupled to an optical power monitor 165 as schematically illustrated in FIG. 6A. The optical power monitor 165 is coupled to an attenuator bank 170 that includes the attenuators 70 for the different channels. The optical power monitor 165 is also coupled to a phase shifter bank 180 that includes the phase shifters 180 for each channel. In certain embodiments, the optical power monitor 165 comprises an array of photodiodes or other photodetectors that are responsive to the power in each of the channels and that generate feedback control signals 167 that are transmitted to the attenuator bank 170 and to the phase shifter bank 180. The attenuator bank 170 and the phase shifter bank 180 respond to the feedback control signals by adjusting the attenuators 70 and phase shifters 80 accordingly. In certain embodiments, each of the attenuators 70 of the attenuator bank 170 is individually addressable and each of the phase shifters 80 of the phase shifter bank 180 is also individually addressable.

The optical power monitor 165 can alternatively be optically coupled to a tap 190 from the optical cavity 40 as schematically illustrated by FIG. 6B. Optical connection is provided through a demultiplexer 200, which separates the optical power into its wavelength components. The channels are then inputted into the optical power monitor 165. In such embodiments, the optical power monitor 165 responds to the various wavelength components in the optical power distribution by generating feedback control signals 167 that are transmitted to the optical equalizer 50.

FIG. 7 is a flowchart of one embodiment of a method 300 of producing a plurality of optical outputs at different wavelengths. As shown by operational block 310, the method 300 comprises pumping a laser gain medium 20 to generate light 30 having a plurality of different wavelengths. The method 300 further comprises resonating the light 30 of the plurality of different wavelengths in an optical cavity 40 as depicted by operational block 320. At operational block 330, a more even distribution of optical power is provided among the plurality of different wavelengths resonating in the optical cavity 40 by adjusting the optical power of at least one of the wavelengths. At operational block 340, a fraction of the light 30 propagating through the optical cavity 40 is coupled out of the optical cavity 40.

In certain embodiments, pumping the laser gain medium 20 in accordance with operational block 310 comprises optically pumping by exposing the laser gain medium 20 to light having sufficient energy to create a population inversion in which higher energy atomic states are populated. In other embodiments, pumping the laser gain medium 20 in operational block 310 comprises electrically pumping by applying a sufficient voltage across the laser gain medium 20 to create a population inversion. Persons skilled in the art are able to select an appropriate pumping mechanism for the laser gain medium 20.

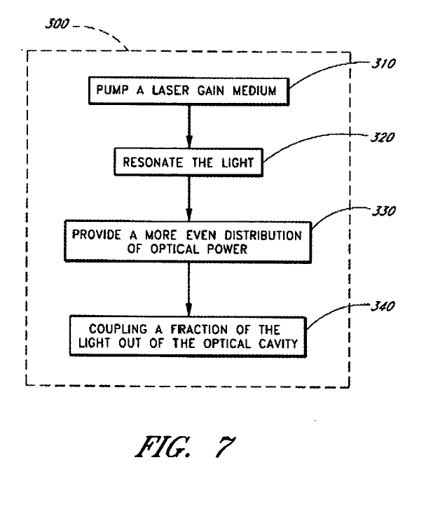

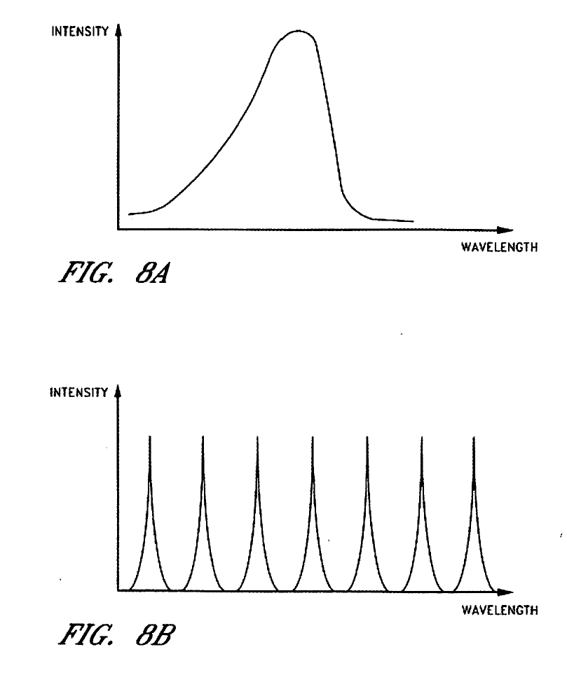

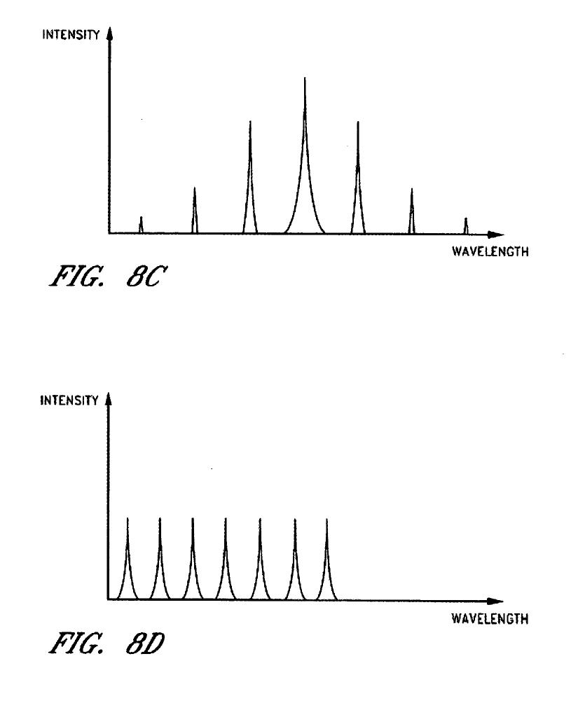

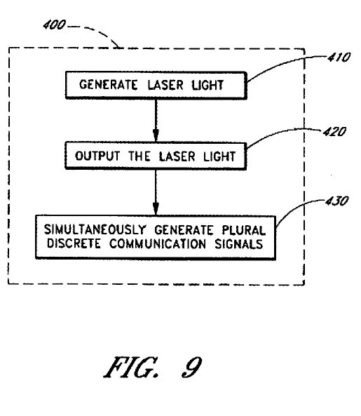

Light 30 is generated by the decay from heavily populated excited atomic states to a lower-lying atomic states associated with the laser gain medium 20. In embodiments described herein, the laser gain medium 20 preferably has a relatively broadband gain bandwidth so the light 30 produced comprises a plurality of different wavelengths. In a semiconductor gain medium, this broadening may for example be the result of homogeneous broadening. In an erbium doped fiber amplifier, this broadening may be caused by inhomogeneous broadening. FIG. 8A schematically illustrates an exemplary broadband gain bandwidth.

In certain embodiments, resonating the light 30 of the plurality of different wavelengths in an optical cavity 40 as represented by the operational block 320 comprises circulating the light 30 from the laser gain medium 20 through the optical resonator 40. The optical cavity 40 supports a plurality of axial or longitudinal cavity modes each with a corresponding wavelength and frequency. Light at the wavelengths associated with these longitudinal modes will resonate within the cavity. FIG. 8B schematically illustrates an exemplary set of axial or longitudinal mode resonances for an optical resonator. These modes have respective linewidths and spacings defined by the cavity, e.g., the reflectivity of the reflective surface on the gain medium and the optical path length of the cavity. The particular linewidths and lines spacings will vary for different cavity configurations and sizes and may be designed differently to accommodate various types of gain mediums. In one embodiment, the spacing between neighboring modes of FIG. 8B is equivalent to the free spectral range (FSR) of the ring-resonator 110.

Lasing occurs when the gain introduced over a round trip within the cavity is larger than the losses. This condition can be achieved at those wavelengths for which the optical cavity 40 is resonant. Consequently, the outputted laser light contains a plurality of discrete wavelengths corresponding to the resonant wavelengths of the optical cavity 40. The resultant optical power distribution for the laser source 10, schematically illustrated by FIG. 8C, is a convolution of the exemplary broadband gain bandwidth of FIG. 8A and the axial or longitudinal mode resonances for the optical resonator such as are depicted in FIG. 8B. The resultant optical power is typically not evenly distributed amongst the axial modes, rather, the majority of the optical power is generally contained in only a couple cavity modes as schematically illustrated by FIG. 8C. In particular, many prior art “single-mode” systems seek to maximize the optical power in one cavity mode while minimizing the optical power in the other cavity modes. These lasers may be designed to suppress the sidebands in order to shift more energy into the central peak. Consequently, a single central peak may be obtained that is surrounded by one, two, or three, substantially smaller sidebands on opposite sides of the central peak. The intensity of the central peak may be, for example, from about two to ten or more the times as high as the closest of the surrounding sidebands that are also the largest.

In contrast, the multi-wavelength laser source 10 is preferably designed to more evenly distribute the optical power throughout a plurality of axial modes. Instead of suppressing the sidebands to create an enlarged central peak, the attenuators preferably adjust the power such that optical energy is approximately balanced in a plurality of modes. For example, the attenuators may be configured to prevent any one of the modes from being substantially larger than the others. In this manner, optical energy from a given peak is distributed to other surrounding peaks such that no single peak substantially dominates. Preferably, in certain embodiments, the variation in intensity between the plurality of channels is not larger than about 20% or 25% of their average intensity. More preferably, the variation between the plurality of channels is not larger than about 10% or 15% of their average intensity. The number of such channels is preferably greater than about 10, more preferably greater than about 20, and most preferably greater than about 30 or 40 channels.

Accordingly, instead of suppressing the side bands that might otherwise surround a central peak, optical power is removed from the otherwise central peak and distributed among the side bands.

In this manner, optical energy from a given axial mode is distributed to other surrounding axial modes such that no single axial mode substantially dominates. Accordingly, optical power of at least one of the wavelengths is adjusted. More preferably, the optical power in 10, 20, 30, 40, or more longitudinal modes is varied so as to have larger and substantially more equal intensities. In particular, the filtering and feedback functions described above operate to cause the gain of these 10, 20, 30, 40 or more axial modes to be larger than the losses such that lasing of these optical modes can occur.

Various embodiments of the apparatus schematically illustrated by FIGS. 1-6B are used to controllably adjust the optical power of at least one, more preferably, three or five or more longitudinal modes. By selectively adjusting the attenuator 70 and the phase shifter 80 for one of the plurality of channels, the power contained in the corresponding cavity mode can be changed relative to the power contained in the other cavity modes. For example, by increasing the optical loss along the channel path corresponding to a particular wavelength, the quality factor Q for the cavity mode resonant at that wavelength is reduced relative to the quality factors of the other cavity modes. In this way, the optical power of the particular mode is reduced relative to the optical power of the other mode. Conversely, by decreasing the attenuation and optical loss along a channel path, the quality factor, Q, for the cavity mode resonant at that wavelength is increased. Similarly, the quality factor, Q, for a cavity mode can be varied by using the phase shifter 80 to control the optical path length for a particular channel. In this manner, the cavity resonance can be tuned varying the amount of loss or resonance at a particular wavelength. In another embodiment, the phase shifter 80, if used to tune the mode of the greater external cavity off the mode of the filter feedback, may simultaneously be used as an attenuator. Thus, the resultant optical power distribution can thereby be adjusted by controlling the attenuations and phase shifts corresponding to the plurality of wavelengths associated with the appropriate channels.

FIG. 8D schematically illustrates an exemplary optical power distribution in which the optical power is more evenly distributed among the plurality of different wavelengths resonating in the optical cavity 40. As used herein, the term “more evenly distributed” refers to a comparison of the optical power distribution resulting from the optical equalizer 50 adjusting the optical power of at least one wavelength with the optical power distribution resulting from the optical equalizer 50 not adjusting the optical power of at least one wavelength. Seven exemplary channels having substantially the same intensity and associated optical power are depicted in FIG. 8D. As described above, more or less channels having substantially the same intensity or optical power may be present in other embodiments. Still other optical power distributions beyond the exemplary optical power distribution of FIG. 8D are possible. In certain embodiments, for instance, specific channels can be removed as desired by attenuating the associated wavelengths. The selection of which optical modes and wavelengths are provided as output may vary, for example, depending on the application.

Outputting light from the multi-wavelength light source 10 comprises optically coupling a fraction of the light propagating through the optical cavity 40 out of the cavity 40 as represented by the operational block 340. Optically coupling may be completed using a Y-coupler included in the optical cavity 40. FIGS. 2-4 and 6A-B schematically illustrate various embodiments in which a Y-coupler 90 is used. Other configurations for coupling the light out of the optical cavity 40 are compatible with embodiments described herein. For example, partially transmitting and partially reflecting surfaces may be employed in other designs.

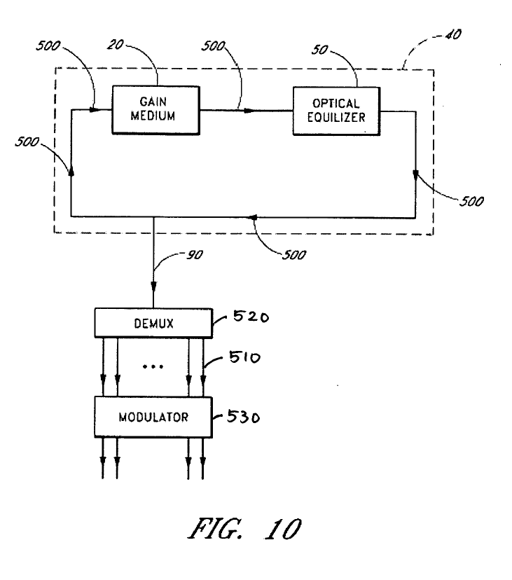

FIG. 9 is a flowchart of an embodiment of a method 400 of producing optical signals for optical communications. FIG. 10 schematically illustrates an exemplary apparatus used to perform the method 400. As represented by an operational block 410, the method 400 preferably comprises generating laser light through at least a substantial portion of the gain bandwidth of a laser medium 20 disposed in a resonant cavity 40. In an operational block 420, the laser light is output from the laser medium 20 as a gain medium signal 500. The method 400 further comprises simultaneously generating plural discrete communication channels 510 from the laser light as illustrated by operational block 430. To accomplish this task, the optical power distribution of the gain medium signal 500 is repetitively modified and this modified gain medium signal 500 is repetitively fed back to the laser medium 20.

As discussed above, in certain embodiments generating laser light through at least a substantial portion of the gain bandwidth of a laser medium 20 disposed in a resonant cavity 40 in the operational block 410 comprises pumping the laser medium 20 to create a population inversion in an excited state. Upon decaying from the excited state to a lower state, the laser medium 20 generates laser light. This laser light is preferably generated through at least a substantial portion of the gain bandwidth of the laser medium 20. FIG. 8A schematically illustrates an exemplary gain bandwidth for a laser medium 20 in accordance with embodiments described herein.

In certain embodiments, outputting the laser light from the laser medium 20 as a gain medium output 500 comprises transmitting the laser light to an optical equalizer 50. Various embodiments of the optical equalizer 50 schematically illustrated by FIGS. 1-6B are compatible with the method 400. Since the laser light is created in a resonant cavity 40, the gain medium output 500 represents a convolution of the gain bandwidth of the laser medium 20 and the cavity modes of the optical cavity 40, as described above. As such, the gain medium output 500 comprises a plurality of discrete communication channels 510 wherein each discrete communication output 510 corresponds to a resonant wavelength of the optical cavity 40.

Simultaneously generating plural discrete communication channels from the laser light of the operational block 430 preferably comprises repetitively modifying the optical power distribution of the gain medium signal 500 and repetitively feeding the modified gain medium signal 500 back to the laser medium 20. In certain embodiments, as described above, the optical equalizer 50 is responsive to a feedback signal indicative of the optical power distribution of the gain medium signal 500. The optical equalizer 50 responds to the feedback signal by adjusting the attenuation and phase shifts of the channels corresponding to the various resonant wavelengths of the optical cavity 40. Thus, the optical equalizer 50 repetitively modifies the optical power of each of the discrete communication channels 510, thereby repetitively modifying the optical power distribution of the gain medium output 500. As part of the resonant cavity 40, the optical equalizer 50 is configured to repetitively feed the modified gain medium output 500 back to the laser medium 20.

In certain embodiments, the method 400 further comprises separately modulating each of the discrete communication channels 510 to encode information thereon. As schematically illustrated in FIG. 10, a tap 90 transmits a fraction of the modified gain medium signal 500 out of the resonant cavity 40 to a demultiplexer 520. The demultiplexer 520 separates the modified gain medium output 500 into the discrete communication channels 510 which are transmitted to a modulator 530. In certain embodiments, the modulator 530 separately modulates each of the discrete communication channels 510, thereby encoding information on each of the channels 510. Various exemplary modulators 530 that are compatible with embodiments described herein comprise an electro-optical device that responds to an electrical signal by changing its refractive index. Other types of modulators are also considered possible as described above.

In yet another embodiment, the attenuators 80 in the multi-wavelength laser source 10 can be employed to modulate the channels and impart data or otherwise encode information thereon.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A multi-wavelength light source, comprising:
a gain medium which emits light of a plurality of wavelengths in response to pumping, the gain medium disposed in an optical cavity which repetitively passes light through the gain medium; and
an optical equalizer in the optical cavity, the optical equalizer adjusting the optical power of at least one of the wavelengths so as to provide more even optical power distribution among the plurality of wavelengths propagating through the optical cavity.

2. The multi-wavelength light source of claim 1, the optical equalizer adjusting the optical power of at least 10 of the wavelengths so as to provide more even optical power distribution among the plurality of wavelengths.

3. The multi-wavelength light source of claim 1, the optical equalizer adjusting the optical power of at least 20 of the wavelengths so as to provide more even optical power distribution among the plurality of wavelengths.

4. The multi-wavelength light source of claim 1, wherein the gain medium is an indium phosphide-based semiconductor gain medium.

5. The multi-wavelength light source of claim 1, wherein the gain medium comprises an erbium-doped glass fiber.

6. The multi-wavelength light source of claim 1, wherein the gain medium comprises a first end and a second end, said gain medium having a reflector at the first end, the second end of the gain medium being optically coupled to the optical equalizer.

7. The multi-wavelength light source of claim 6, wherein the first end comprises a dielectric mirror.

8. The multi-wavelength light source of claim 1, wherein the gain medium comprises a first end and a second end, and the optical equalizer is optically coupled to the first end of the gain medium and the second end of the gain medium to form a ring cavity configuration.

9. The multi-wavelength light source of claim 1, wherein the optical equalizer is formed on a silicon-on-insulator chip.

10. The multi-wavelength light source of claim 1, wherein the gain medium comprises a semiconductor optical amplifier, the optical equalizer is formed on a silicon-on-insulator chip, and the semiconductor optical amplifier is optically coupled to the silicon-on-insulator chip via waveguides having a coupling region comprising at least one of an antireflection coating and an angled chip interface.

11. The multi-wavelength light source of claim 1, wherein the optical equalizer comprises:
a first multiplexer/demultiplexer having a first multiplexed light waveguide and a first plurality of demultiplexed light waveguides for propagating multiplexed and demultiplexed light respectively, the first multiplexed light waveguide optically coupled to the gain medium;
a second multiplexer/demultiplexer having a second multiplexed light waveguide and a second plurality of demultiplexed light waveguides for propagating multiplexed and demultiplexed light respectively, the second multiplexed light waveguide optically coupled to the gain medium, each of the second plurality of demultiplexed light waveguides optically coupled to a corresponding one of the first plurality of demultiplexed light waveguides;
a plurality of attenuators, wherein each attenuator is optically coupled to a corresponding one of the first plurality of demultiplexed light waveguides and to a corresponding one of the second plurality of demultiplexed light waveguides; and
a plurality of phase shifters, wherein each phase shifter is optically coupled to a corresponding one of the first plurality of demultiplexed light waveguides and to a corresponding one of the second plurality of demultiplexed light waveguides in series with a corresponding one of the plurality of attenuators.

12. The multi-wavelength light source of claim 11, wherein the first multiplexer/demultiplexer is an arrayed waveguide grating and the second multiplexer/demultiplexer is an arrayed waveguide grating.

13. The multi-wavelength light source of claim 1, wherein the optical cavity comprises:
a Y-junction optically coupled to the gain medium;
a first waveguide optically coupled to the gain medium via the Y-junction;
a second waveguide optically coupled to the gain medium via the Y-junction; and
a plurality of filter elements optically coupled in parallel between the first waveguide and the second waveguide, wherein each filter element transmits a different wavelength between the first waveguide and the second waveguide.

14. The multi-wavelength light source of claim 13, wherein light from the gain medium is split substantially equally between the first waveguide and the second waveguide by the Y-junction.

15. The multi-wavelength light source of claim 13, wherein each filter element comprises a ring resonator.

16. The multi-wavelength light source of claim 13, wherein the optical equalizer further comprises a plurality of phase shifters, wherein each filter element is optically coupled to a corresponding one of the plurality of phase shifters.

17. The multi-wavelength light source of claim 13, wherein the optical equalizer comprises a plurality of optical attenuators, wherein each filter element is optically coupled to a corresponding one of the plurality of optical attenuators.

18. The multi-wavelength light source of claim 1, wherein the optical cavity comprises a plurality of filter elements optically coupled in parallel to the gain medium, wherein each filter element transmits a different set of wavelengths.

19. The multi-wavelength light source of claim 18, wherein the optical equalizer comprises a plurality of optical attenuators, wherein each filter element is optically coupled to a corresponding one of the plurality of optical attenuators.

20. The multi-wavelength light source of claim 18, wherein the optical equalizer comprises a plurality of phase shifters, wherein each filter element is optically coupled to a corresponding one of the plurality of phase shifters.

21. The multi-wavelength light source of claim 1, further comprising an optical power monitor optically coupled to the optical equalizer, wherein the optical power monitor responds to a measured optical power distribution by transmitting a feedback signal to the optical equalizer.

22. The multi-wavelength light source of claim 18, wherein the optical power monitor is optically coupled to the optical equalizer via a plurality of taps, wherein respective taps are optically coupled to optical paths through said plurality of filter elements, respectively.

23. The multi-wavelength light source of claim 18, wherein the optical power monitor is optically coupled to the optical equalizer via a single tap and a demultiplexer, wherein the tap transmits light from the optical cavity to the demultiplexer and the demultiplexer separates the light into a plurality of channel corresponding to the plurality of wavelengths.

24. A method of producing a plurality of optical outputs at different wavelengths, the method comprising:
pumping a laser gain medium to generate light having a plurality of different wavelengths;
resonating the light of the plurality of different wavelengths in an optical cavity;
providing a more even distribution of optical power among the plurality of different wavelengths resonating in the optical cavity by adjusting the optical power of at least one of the wavelengths; and
coupling a fraction of the light propagating through the optical cavity out of the optical cavity.

25. A method of producing optical signals for optical communications, the method comprising:
generating laser light through at least a substantial portion of the gain bandwidth of a laser medium disposed in a resonant cavity;
outputting the laser light from the laser medium as a gain medium signal; and
simultaneously generating plural discrete communication signals from the laser light by repetitively modifying the optical power distribution of the gain medium signal and repetitively feeding the modified gain medium signal back to the laser medium.

26. The method of claim 25, further comprising separately modulating each of the discrete communication signals to encode information thereon.
